(19) United States
(12) Patent Application Publication
(10) Pub. No.: US 2007/0138447 A1
(43) Pub. Date: Jun. 21, 2007

(54) Method of producing ceramic raw material and ceramic molded body

(75) Inventors: Atsushi Yamada, Nagoya (JP); Tomoyasu Watanabe, Kariya-shi (JP); Akihiko Tsunekawa, Yokkaichi-shi (JP); Makoto Nakae, Nagoya (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/635,009

(22) Filed: Dec. 7, 2006

(30) Foreign Application Priority Data
Dec. 19, 2005 (JP) 2005-365251
Aug. 31, 2006 (JP) 2006-236351

(51) Int. Cl. H01B 1/22

(52) U.S. Cl. 252/514

(57) ABSTRACT

A method of producing a ceramic raw material has steps of adding water into ceramic particles in order to produce a ceramic particle dispersed liquid, adding water into resin component in order to produce a resin component dispersed liquid, mixing the ceramic particle dispersed liquid and the resin component dispersed liquid in order to produce a mixed slurry, and freezing and drying the mixed slurry. In particular, the method further has filtering the ceramic particle dispersed liquid and the resin component dispersed liquid to eliminate coarse particles of not less than 100 μm from each liquid. Further, a method of producing a ceramic molded body has steps of adding water into the above ceramic raw material and then extruding the mixed material by applying a pressure of a range of 1 to 50 MPa.

### CROSS-REFERENCE TO RELATED APPLICATIONS

This application is related to and claims priority from Japanese Patent Applications No. 2005-365251 filed on Dec. 19, 2005 and No. 2006-236351 filed on Aug. 31, 2006, the contents of which are hereby incorporated by reference.

### BACKGROUND OF THE INVENTION

1. Field of the Invention

The present invention relates to a method of producing a ceramic raw material and a ceramic molded body, and more particularly, relates to a method of producing a ceramic raw material composed of ceramic particles and resin component uniformly dispersed and of producing a ceramic molded body made from the produced ceramic raw material.

2. Description of the Related Art

Sintered ceramic products such as sintered ceramic bodies made from various kinds of ceramics have been widely used as many types of sensor elements such as condenser ceramics, piezoelectric element gas sensors, honeycomb structure bodies, and gas sensors. Such sintered ceramic products are produced by mixing ceramic particles and binders (as resin components) with a plasticizer and then shaping the mixed one.

However, such a conventional production method mainly having steps of mixing and shaping ceramic particles and resin component includes a drawback of causing a distribution variation of the resin component in a molded product (or a shaped product). If such a molded product is fired, porous parts such as voids and pores are generated in a sintered product. This causes a possibility of deteriorating the strength of the sintered product and of having different ceramic characteristics of each part in the sintered product.

There is another conventional method of producing a ceramic molded product by dispersing ceramic particles and resin component into an organic solvent in order to make a mixed slurry, and then removing the organic solvent from the mixed slurry by heating it based on a doctor blade manner and the like, and by finally drying the mixed slurry. Japanese patent laid open publications No. JP H4-265701 and JP H4-145693 have disclosed such a doctor blade manner.

However, in general, because such a conventional manner includes the difficulty of uniformly dispersing the resin component in the mixed slurry, a distribution variation of the resin-component occurs in a finally-produced ceramic molded product, that is, the distribution of the resin component in the product becomes uniform. As described above, the conventional manner cannot adequately disperse the ceramic particles and resin component in the mixed slurry because of forming steric hindrance of the resin component dissolved in the organic solvent between the ceramic particles. Because an organic solvent is capable of dissolving the resin component, the organic solvent has a weak hydrogen-bonding strength in view of necessary dispersion capability. That is, there is a possibility that the conventional manner described above can not adequately disperse the ceramic particles and resin component in the mixed slurry. Although the conventional manner performs a drying step of drying the mixed slurry by heating, it causes the cohesion of the resin components during the drying step. As a result, the resin components cannot be uniformly dispersed in the dried molded product.

### SUMMARY OF THE INVENTION

It is an object of the present invention to provide an improved method of producing a ceramic raw material at a low manufacture cost, in which the produced ceramic raw material is composed of ceramic particles and resin component that are uniformly dispersed therein. It is also another object of the present invention to provide a method of efficiently producing a ceramic molded body made from the ceramic raw material at a low manufacture cost. To achieve the above purposes, the present invention provides a method of producing a ceramic raw material composed mainly of at least ceramic particles and resin component having steps of producing a ceramic particle dispersed liquid by mixing ceramic particles and water (or pure water), producing a resin component dispersed liquid by mixing resin component and water (or pure water), producing a mixed slurry by mixing the ceramic particle dispersed liquid and the resin component dispersed liquid, and producing the ceramic raw material by freezing and drying the mixed slurry.

In the method of the present invention, the ceramic raw material composed mainly of the ceramic particles and the resin component is produced by performing the ceramic particle dispersing step, the resin component dispersing step, the mixing step, and the drying step.

The ceramic particle dispersing step produces the ceramic particle dispersed liquid by adding water into the ceramic particles and mixing them. The resin component dispersing step produces the resin component dispersed liquid by adding water into the resin component and mixing them. Both of the above dispersing steps use water as a solvent capable of having a large hydrogen-cohering or bonding force, and further disperse the ceramic particles and the resin component into the different liquids, independently. This manner can adequately and uniformly disperse the ceramic particles and the resin component, respectively, in each liquid.

Further, the mixing step mixes the ceramic particle dispersed liquid and the resin component dispersed liquid in order to produce the mixed slurry. That is, in the method of the present invention, after preparing the ceramic particle dispersed liquid and the resin component dispersed liquid by dispersing each of the ceramic particles and the resin component into the water as the solvent, respectively, and both of the ceramic particle dispersed liquid and the resin component dispersed liquid are mixed together in order to produce the mixed slurry.

When compared with a conventional manner in which the ceramic particles and resin component are simultaneously mixed into water as a solvent, the method of the present invention is capable of uniformly dispersing the ceramic particles and resin component in the mixed slurry.

Still further, because the method according to the present invention freezes and dries the mixed slurry, it is possible to prevent the cohesion of the resin component by the heating step. As a result, the method of the present invention can provide the ceramic raw material in which the ceramic particles and the resin component are uniformly dispersed therein.

According to another aspect of the present invention, there is provided a method of producing a ceramic molded body having steps of adding water into the ceramic raw material produced by the method according to the present invention, then mixing the ceramic raw material and the water, and extruding the mixed material by applying a pressure within a range of 1 MPa to 50 MPa, and finally molding the mixed material in order to produce a ceramic molded body.

The method of producing a ceramic molded body according to the present invention uses the ceramic raw material, obtained by the improved manner described above, having the uniformly dispersed ceramic particles and resin component. It is therefore possible to produce the ceramic molded body having the ceramic particles and resin component uniformly dispersed therein. In addition, the mixed material is produced by adding the water into the ceramic raw material and then by molding the mixed material while applying the pressure within a range of 5 MPa to 50 MPa. In a concrete example, the mixed material is extruded through a thin slit while applying the pressure of a range of 5 MPa to 50 MPa to the mixed material.

It is thereby possible to crush the resin component in its high concentration part involved in the mixed material during extruding and molding and to further decrease the variation of the resin component in the ceramic molded material finally produced. As a result, the method according to the present invention can provide the ceramic molded body with the uniformly dispersed ceramic particles and resin component therein.

The ceramic molded body can be applicable to various applications and used as a sintered body obtained by firing. As described above, because the ceramic molded body has the uniformly dispersed ceramic particles and resin component therein, this can avoid the generation of porous parts such as voids and pores on the surface or in the inner part of the sintered body after firing. It is thereby possible to obtain the sintered body of a uniform ceramic characteristic such as strength without variation in each part.

In the method of producing a ceramic raw material according to the present invention, it is preferred to mix ceramic particles and water, where the water has a range of 20 to 80 parts by weight in the mixed material of 100 parts by weight. If the water is less than 20 parts by weight, there is a possibility of hardly dispersing the ceramic particles in the water as a solvent. On the contrary, if the water is over 80 parts by weight, there is a possibility of taking a long time necessary for adequately drying the mixed material in the freezing and drying step. It is therefore preferred to have the water of a range of 20 to 80 parts by weight, more preferably, to have the water of a range of 35 to 60 parts by weight, and mostly preferably, to have the water of a range of 45 to 55 parts by weight.

Still further, in the method of producing ceramic raw material according to the present invention, it is preferred that the ceramic particles is at least one kind of components selected from the group of aluminum titanate (Al₂TiO₅), mullite (3Al₂O₃.2SiO₂), potassium titanate (K₂O.nTiO₂), Lithium aluminosilicate, cordierite, titanate zirconate (PZT), titanium oxide (TiO₂), tin oxide (SnO₂), Gallium arsenide (GaAs), silicon carbide (SiC), chromic oxide (Cr₂O₃), zirconia (PSZ), alumina (Al₂O₃), yttria (Y), silicon nitride (Si₃N₄), glaphite fiber, calcium silicate (3CaO.SiO₂), crystallized glass, unstable carbon, tungsten carbide (WC), titanium carbide (TiC), iron Silicide (FeSi₂), graphite, titania (titanium oxide TiO₂), carbon fiber, silica (SiO₂), aluminum nitride (AlN), barium titanate (BaTiO₃), zinc oxide (ZnO), zinc sulfide (ZnS), gallium phosphide (GaP), tungstic oxide (WO₂), cadmium sulfide (CdS), and Indium Tin oxide (ITO).

The kind of the ceramic particles for producing the ceramic raw material can be optionally selected according to the applications. For example, a gas sensor element is produced from the ceramic raw material such as one or more ceramic particles, zirconia (PSZ), alumina (Al₂O₃), and yttria (Y).

Still further, in the method of producing ceramic raw material according to the present invention, it is preferred that the ceramic particle dispersed liquid is filtered or classified in order to eliminate and classify coarse particles having a grain size or diameter of at least not less than 100 μm. This case has a possibility of producing the ceramic raw material of a high quality having an approximate same grain size or diameter, not including coarse particles as an expected factor which may cause defects.

That is, because the ceramic particles are generally produced from natural raw materials, they involve coarse particles. Such coarse particles are not crushed in an appropriate dimension during the ceramic raw material production process.

If the ceramic raw material, produced by the production manner according to the present invention, involves many coarse particles having a grain size or diameter of not less than 100 μm, this causes a possibility of generating the defects by the presence of the coarse particles in the ceramic product finally produced. That is, in general, when a stress of a constant magnitude or a voltage is applied to the ceramic product, there is a possibility of causing cracks therein based on the presence of the coarse particle. In order to avoid the generation of such defects, the coarse particles are eliminated in advance from the ceramic particle dispersed liquid by performing the filtering and classifying step, it is possible to produce the ceramic raw material not involving any defect factor. The ceramic product produced by the ceramic raw material thereby hardly causes defects even if various stresses are applied to the ceramic product in commercial working and use.

Moreover, in the method of producing ceramic raw material according to the present invention, it is preferred that the ceramic particle dispersed liquid is filtered and classified in order to eliminate and classify coarse particles having a grain size or diameter of at least not less than 5 μm from the ceramic particle dispersed liquid. This manner can produce the ceramic raw material of a high quality having an approximate same grain size or diameter, not having coarse particles as an expected factor which may generate defects. This condition can further eliminate the generation of defect and can obtain the appropriate ceramic raw material applicable to automobile parts such as a gas sensor.

If the ceramic raw material, produced by the production manner according to the present invention, involves plural coarse particles having a grain size or diameter of not less than 100 μm, there is a possibility of causing the defects by the presence of such coarse particles in the ceramic product finally produced. That is, in general, when a stress of a constant magnitude or a voltage is applied to the ceramic product, there is a possibility of causing cracks based on the presence of such coarse particle. In order to avoid the generation of the defects, the coarse particles are eliminated in advance from the ceramic particle dispersed liquid by performing the filtering and classifying step, it is possible to produce the ceramic raw material not involving defect factor. The ceramic product produced by the ceramic raw material causes hardly defects even if various stresses are applied to the ceramic product in commercial use.

Furthermore, in the method of producing ceramic raw material according to the present invention, it is preferred to mix the resin component and the water in which the water of a range of 50 to 99 parts by weight in the mixed material of 100 parts by weight. If the water is less than 50 parts by weight, there is a possibility of hardly dispersing the resin component in the water as the solvent. On the contrary, if the water is over 99 parts by weight, there is a possibility of taking a long time necessary for drying the mixed material in the freezing and drying step. Therefore it is more preferred to have the water of a range of 85 to 99 parts by weight, and more preferably to have the water of a range of 97 to 99 parts by weight.

Still further, in the method of producing ceramic raw material according to the present invention, it is preferred that the resin component is at least one kind of components selected from the group of methyl cellulose (MC), hydroxypropyl methylcellulose, carboxymethyl cellulose (CMC), hydroxyethyl cellulose (HEC), starch, polyvinyl alcohol (PVA), polyethylene oxide (PEO), sodium polyacrylate, and polyacrylamide (PAA).

Still further, in the method of producing ceramic raw material according to the present invention, it is preferred that the resin component dispersed liquid is filtered or classified in order to eliminate and classify coarse particles having a grain size or diameter of at least not less than 100 μm. In this case, it is possible to produce the ceramic raw material of a high quality having an approximate same grain size or diameter, not including coarse particles as the factor which generates defects. That is, similar to the case of the ceramic particles, because the resin component is generally produced from natural raw materials, they involve a partial dissolved component even if they are produced in a same condition. This thereby has a possibility of generating coarse particles from the dissolved component. Such a coarse particle in the resin component may generate the defects, like the case of the coarse ceramic particle. In order to avoid the generation of defects, the coarse particles of at least not less than 100 μm are eliminated in advance from the resin component dispersed liquid by performing the filtering and classifying step, it is thereby possible to produce the ceramic raw material which does not have such a defect factor. The ceramic product produced by the ceramic raw material causes hardly defects even if various stresses are applied to the ceramic product in commercial working and use.

Further, according to the method of producing a ceramic raw material of the present invention, it is more preferred that the resin component dispersed liquid is filtered or classified in order to eliminate and classify coarse particles having a grain size or diameter of at least not less than 5 μm. In this case, it is possible to produce the ceramic raw material of a high quality having an approximate same grain size or diameter, not having coarse particles as an expected factor which may generate defects. This condition can further eliminate the generation of the defect and obtain the appropriate ceramic raw material suitably applicable to automobile parts such as a gas sensor.

It is preferred to use a mesh whose aperture has a half dimension of the grain-particle to be eliminated when the filtering and classifying is performed for the resin component dispersed liquid. That is, when the coarse particle of a grain size or diameter of not less than 100 μm is eliminated from the resin component dispersed liquid, it is preferred to use the mesh having an aperture of 50 μm. In this case, even if the coarse particle in the resin component is deformed in filtering, it is possible to certainly eliminate the coarse particle having not less than a specified grain size or diameter.

Further, it is preferred to have a solid component ratio of the mixed slurry in which the solid component of a range of 70 to 99 wt % in the mixed slurry of 100 wt % o.

If the solid component ratio is less than 70 wt %, there is a possibility of taking a long drying time for drying the mixed slurry in the freezing and drying step. On the other hand, the solid component ratio is over 99 wt %, there is a possibility of hardly dispersing the ceramic particles and the resin component in the mixed slurry. It is therefore preferred to have the solid component ratio of a range of 75 to 95 wt %, and more preferred to have the solid component ratio of a range of 80 to 90 wt %.

In the above cases, such a solid component ratio means a ratio of the solid component by weight percent in the total weight of the mixed slurry.

Further, in the method of producing ceramic raw material according to the present invention, it is more preferred to further filter the mixed slurry in order to eliminate and classify the coarse particles in the ceramic particles and the resin component having a grain diameter of at least not les than 100 μm from the mixed slurry. In this manner, like the filtering and classifying step for the ceramic particle dispersed liquid and the resin component dispersed liquid, it is possible to produce the ceramic raw material involving hardly defect factor.

It is more preferred to eliminate the ceramic particle and the resin component of a grain-size of not less than 5 μm from the mixed slurry. In this case, it is possible to further prevent the occurrence of defects and to obtain the ceramic raw material suitably applicable to parts in the automobile field such as a gas sensor.

Still further, in the drying step, the frozen mixed slurry is heated under a low-pressure condition in order to dry the mixed slurry. It is preferred to perform the freezing step for the mixed slurry under a temperature of a range of −200° C. to −5° C. for a time length of a range of 30 minutes to 240 minutes.

When the freezing temperature is less than −200° C., the introduction cost for the freezing apparatus (because such a freezing apparatus is expensive) and its operation cost for continuously maintaining a low temperature condition become high. This increases the total production cost of producing the ceramic raw material. On the contrary, when the freezing temperature is set to more than −5° C., it takes a long freezing time necessary to freeze the mixed slurry and this decreases the dispersion rate of the ceramic particles and resin component in the mixed slurry. It is therefore preferred to have the temperature range of −50° C. to −20° C., and more preferred to have the temperature of −35° C. in view of the valance in freezing speed and production cost.

Further, when the freezing time is less than 30 minutes, there is a possibility of decreasing the degree of dispersion of the ceramic particles and the resin component in the mixed slurry because the mixed slurry cannot be frozen adequately. On the other hand, even if the freezing time is over the 240 minutes, it is impossible to have the effect to the time and cost, namely, the production requires a long time and the production cost is thereby increased. Accordingly, it is preferred to have the freezing time of a range of 60 minutes to 180 minutes, more preferred to have the freezing time of a range of 90 minutes to 150 minutes.

Still further, it is preferred to carry out the drying step of drying the frozen material under the condition where a degree of vacuum has a range of 5 Torr to 50 Torr, a heating temperature has a range of 20° C. to 70° C., and a heating time takes a range of 4 hours to 24 hours.

If the degree of vacuum is less than 5 Torr, the introduction cost of the drying apparatus for generating and its operation cost of maintaining the vacuum state become expensive, the total production cost of the ceramic raw material becomes thereby high. This is unprofitable.

On the contrary, when the degree of vacuum is less than 50 Torr, the water component involved in the frozen mixed slurry cannot be adequately sublimated. There is a possibility that the frozen slurry is dissolved during the drying step. It is therefore preferred to have the degree of vacuum within a range of 5 Torr to 20 Torr.

Furthermore, under the condition of the heating temperature of less than 20° C. or of the heating time of less than 4 hours, there is a possibility of becoming difficult to adequately eliminate the water component from the frozen slurry and difficult to adequately dry the mixed slurry.

On the contrary, when the heating temperature is over 70° C., there is a possibility of causing the cohesion of the resin component in the mixed slurry. Still further, even if the mixed slurry is heated for 24 hours or more, it is difficult to obtain a remarkable effect by such a long-time heating. This case increases the total production cost. Accordingly, it is preferred to have the heating temperature of a range of 30° C. to 65° C., and more preferred to have the heating temperature of a range of 40° C. to 65° C. In addition, it is preferred to have the heating time of a range of 6 hours to 20 hours, more preferred to have the heating time of a range of 8 hours to 18 hours.

Furthermore, according to the present invention, it is possible to produce a ceramic molded body by extruding and molding the ceramic raw material produced by the improved method described above. In a concrete example, the ceramic molded body can be produced by mixing the ceramic raw material and water, by extruding the mixed material while applying a pressure of a range of 1 MPa to 50 MPa, and by molding the ceramic molded body. It is preferred to mix the ceramic raw material and the water where the water has a range of 1 to 20 parts by weight in the total of the ceramic raw material and the water of 100 parts by weight.

When the amount of water is less than 1 part by weight, it is difficult to mix the ceramic raw material and water because the amount of water is little. On the contrary, when the amount of water is over 20 parts by weight, the resin component is dissolved again because of the presence of a large amount of water. It is more preferred that the amount of water is within a range of 2 to 8 parts by weight, and still mostly preferred for the water to have a range of 4 to 6 parts by weight.

Still further, it is preferred to apply the pressure of a range of 1 MPa to 50 MPa to the mixed material during molding.

In this condition, even if the mixed material includes the variation of the resin component, the applied pressure can eliminate such a variation of the resin component, and decrease the degree of the variation of the resin component as low as possible. When the applied pressure is less than 1 MPa, there is a possibility of hardly eliminating the variation of the resin component in the ceramic raw material. On the contrary, when the applied pressure is over 50 MPa, it has been recognized and known in the related art that the effect to decrease the variation becomes low. Therefore it is more preferred to apply the pressure within a range of 5 MPa to 30 MPa, and mostly preferred to apply the pressure within a range of 5 MPa to 20 MPa.

Still further, it is preferred to use the ceramic molded body as a gas sensor. In this case, it is possible for the gas sensor to have the superior features of the ceramic molded body having less variation and porous parts (such as pore and void). There is a recent trend that the size of a gas-sensor is more and more decreased and the allowable working temperature thereof becomes increased as high as possible. It is thereby required to have a high strength and a high thermal resistance. On the other hand, there is a strong possibility of causing porous parts such as pores and voids on the surface and in the inside of the gas sensor element on sintering the ceramic molded body having a large variation of the resin component. This decreases the strength and the thermal resistance of the gas sensor product. On the contrary, because the present invention can provide the ceramic molded body having a low variation, it is possible to form the sintered body having no porous parts such as pores and voids. The sintered body produced by the manner of the present invention can be applied to a gas sensor element, and it is possible to make a gas sensor having the superior strength and superior thermal resistance provided from the superior characteristics of the ceramic molded body produced by the method of the present invention.

### BRIEF DESCRIPTION OF THE DRAWINGS

A preferred, non-limiting embodiment of the present invention will be described by way of example with reference to the accompanying drawings, in which:

FIG. 1 is a bar graph showing the incidence of particles having various grain sizes in a mixed slurry as Experimental sample X according to a first embodiment of the present invention;

FIG. 2 is a bar graph showing the incidence of particles having various grain sizes in a slurry as Experimental sample Y1;

FIG. 3 is a graph showing the incidence of dispersed particles in the mixed slurry as Experimental sample X and in the slurry as Experimental sample Y2;

FIG. 4 is a view showing a configuration of an extrusion molding apparatus for producing ceramic molded bodies according to a second embodiment of the present invention;

FIG. 5 is a sectional view of a shaping die placed in an upper stream side of the extrusion molding apparatus according to the second embodiment;

FIG. 6 is a sectional view of an extrusion part in the shaping die shown in FIG. 5 according to the second embodiment;

FIG. 7 is a view mainly showing a configuration of a drying apparatus according to the second embodiment of the present invention;

FIG. 8 is a SEM photograph of a sintered body (as Experimental sample E2) according to the second embodiment of the present invention;

FIG. 9 is a SEM photograph of a sintered body (as Experimental sample C2) according to the second embodiment of the present invention;

FIG. 10 is a bar graph showing the number of defects (number/mm²) generated in two types of sintered bodies (as Experimental samples E2 and C2) per area according to the second embodiment of the present invention;

FIG. 11 is a bar graph showing the incidence of ceramic particles in a ceramic particle dispersed liquid before filtering according to a third embodiment of the present invention;

FIG. 12 is a bar graph showing the incidence of ceramic particles in the ceramic particle dispersed liquid after filtering according to the third embodiment of the present invention;

FIG. 13 is a bar graph showing the distribution of cohered particles of the resin component per area in a resin component dispersed liquid before and after filtering according to the third embodiment of the present invention;

FIG. 14 is a bar graph showing the distribution of coarse particles per area and particle size in each ceramic molded body (Experimental samples E3a, E4a, and C3a);

FIG. 15 is a flow chart showing the steps of the method of producing a ceramic raw material according to the first embodiment;

FIG. 16 is a flow chart showing the steps of the method of producing a ceramic molded body performed by the extrusion molding apparatus and the drying apparatus according to the second embodiment; and

FIG. 17 is a flow chart showing the steps in the method of producing a ceramic raw material according to the third embodiment.

### DETAILED DESCRIPTION OF THE PREFERRED EMBODIMENTS

Hereinafter, various embodiments of the present invention will be described with reference to the accompanying drawings. In the following description of the various embodiments, like reference characters or numerals designate like or equivalent component parts throughout the several views.

### First Embodiment

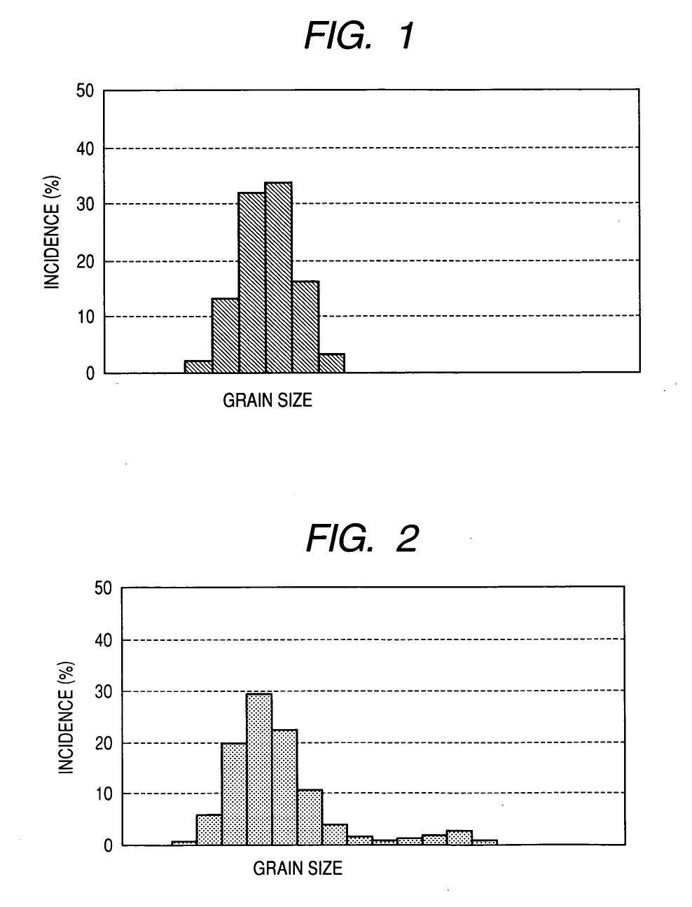

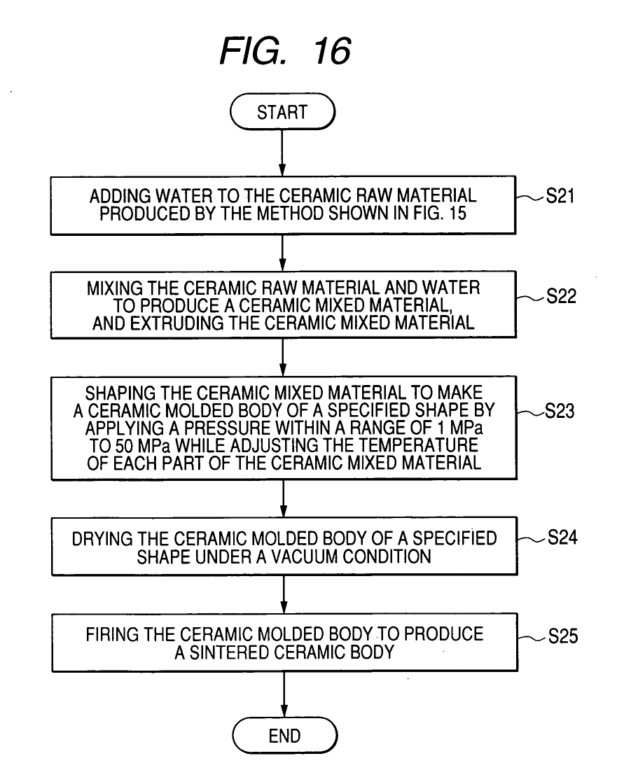

A description will be given of the method of producing ceramic raw material according to a first embodiment of the present invention with reference to FIG. 1 to FIG. 3, and FIG. 15.

FIG. 1 is a bar graph showing the incidence or distribution of grain size of ceramic particles and resin component dispersed in a mixed slurry of Experimental sample X according to the first embodiment.

The method of producing the ceramic raw material composed of ceramic particles and resin component according to the first embodiment has a ceramic particle dispersing step, a resin component dispersing step, a mixing step, and a drying step. FIG. 15 is a flow chart showing those steps of the method of the first embodiment.

In the ceramic particle dispersing step (Step S11), plural ceramic particles are mixed into water (or pure water) as a solvent in order to produce a ceramic particle dispersed liquid.

In the resin component dispersing step (Step S12), the resin component is mixed into water (or pure water) as a solvent in order to produce a resin component dispersed liquid.

In the mixing step (Step S13), the ceramic particle dispersed liquid and the resin component dispersed liquid are mixed together in order to make a mixed slurry.

In the drying step (Step S14), the mixed slurry is frozen and dried in order to produce the ceramic raw material.

In a concrete example of the above production steps, zirconia particles were firstly prepared as the ceramic particles. The zirconia particles of 50 parts by weight were then mixed into pure water of 50 parts by weight in order to make the ceramic particle dispersed liquid (Step S11).

Further, methyl cellulose (MC) was prepared as the resin component. The methyl cellulose of 2 parts by weight was then mixed into pure water of 98 parts by weight in order to make the resin component dispersed liquid (Step S12). In particular, those Steps S11 and S12 were carried out independently and separately.

Next, the ceramic particle dispersed liquid and the resin component dispersed liquid were mixed together in order to make the mixed slurry (as Experimental sample X). The total solid ratio in the mixed slurry became approximately 85 wt % (Step S13).

Next, the mixed slurry was frozen and dried in order to eliminate the water component from the mixed slurry composed of the ceramic particle dispersed liquid and the resin component dispersed liquid by sublimation. In a concrete example, the mixed slurry was firstly frozen at a temperature of −35° C. for 120 minutes, then placed in a vacuum dryer, and then heated at a temperature of 60° C. for 16 hours under the vacuum condition of 10 Torr. The method of producing the ceramic raw material of the first embodiment was thereby completed (Step S14). The produced ceramic raw material will be referred to as Sample E1 later.

Further, another ceramic raw material (as Sample C1) to be compared with Sample E1 according to the present invention was prepared by simultaneously mixing and dispersing both of ceramic particles and resin component into water as a solvent. In a concrete example of producing Sample C1, zirconia particles were firstly prepared as ceramic particles. Methyl cellulose (MC) was prepared as the resin component. The zirconia particles of 14.5 part by weight and the methyl cellulose of 0.5 parts by weight were mixed simultaneously into water of 85 parts by weight in order to make the slurry (Experimental sample Y1) involving the ceramic particles and the resin component dispersed therein. Similar to Sample E1, the produced slurry was frozen and dried in order to make the ceramic raw material as Sample C1.

Next, the distribution of grain size or diameter of the ceramic particles and the resin component in Experimental samples X and Y1 was measured in order to obtain a dispersion state of the ceramic particles and the resin component in Samples E1 and C1.

FIG. 2 is a bar graph showing the incidence or distribution of grain size (or diameter) of the ceramic particles and the resin component dispersed in the slurry of Experimental sample Y1.

The incidence of grain size or diameter of the ceramic particles and the resin component dispersed in Experimental samples Y1 was measured by using a particle size distribution measurement apparatus (Particle size analyzer “Microtrack”, NIKKISO CO., LTD). That is, FIG. 1 and FIG. 2 show the incidence of particle size of the ceramic particles as the measurement result of Experimental samples X and Y1, respectively. Each bar shown in FIG. 1 and FIG. 2 indicates each group of dispersed particles having a specified range of a grain size or diameter and each bar also indicates a frequency (%) of the number of particles in each group to the entire number of the particles.

The first embodiment compares the distribution state of the ceramic particles and the resin component in Experimental sample X with the distribution state of the ceramic particles in the slurry (as Experimental sample Y2) in which only the ceramic particles were dispersed in water.

Experimental sample Y2 was produced by mixing zirconia particles of 50 parts by weight into water of 50 parts by weight. The distribution of dispersed particles in Experimental samples X and Y2 were measured by using the particle size distribution measurement apparatus (Particle size analyzer “Microtrack”, NIKKISO CO., LTD).

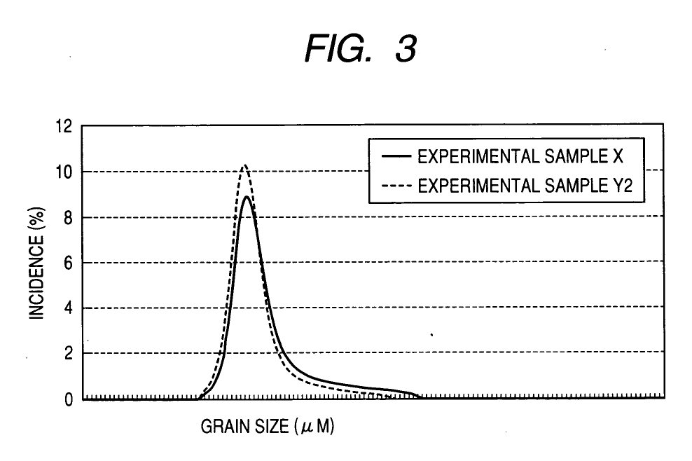

FIG. 3 is a bar graph showing the experimental result. FIG. 3 shows the incidence or distribution of dispersed particles in the mixed slurry of Experimental sample X and in the slurry of Experimental sample Y2. In FIG. 3, the solid line indicates the measurement result of the particle distribution in Experimental sample X, and the dotted line designates the measurement result of the particle distribution in Experimental sample Y2. In FIG. 3, the horizontal line indicates the grain size or diameter (μm) and the vertical line indicates the frequency (%).

As clearly shown from both FIG. 1 and FIG. 2, Experimental sample X has a narrow incidence or distribution of particle size when compared with Experimental sample Y1. That is, the experimental result of the first embodiment clearly shows that Experimental sample X has the uniformly-dispersed ceramic particles and resin component in the mixed slurry rather than that of Experimental sample Y1, in which Experimental sample X was produced by dispersing the ceramic particles into water as a solvent, by dispersing the resin component into water as a solvent independently from the ceramic particles, and then by mixing both the solvents in order to make the mixed slurry. On the contrary, Experimental sample Y1 was produced by simultaneously dispersing ceramic particles and resin component into water as a solvent in order to make the slurry. Accordingly, Sample E1 produced by freezing and drying Experimental sample E1 has a superior uniformly-dispersed ceramic particles and resin component in the mixed slurry when compared with Sample C1 produced by freezing and drying Experimental sample Y1.

As clearly shown in FIG. 3, Experimental sample X has an approximately-uniform particle distribution in the mixed slurry (as Experimental sample Y2) in which only the ceramic particles were dispersed in water. It is therefore understood that the ceramic particles and resin component in Experimental sample X were dispersed in a superior uniformly dispersion state that is approximately the same of that of the slurry in which only the ceramic particles are dispersed.

Because the mixed slurry (Experimental sample X) corresponding to the ceramic raw material (Sample E1) produced by freezing and drying Experimental sample X can be dried while maintaining the superior dispersed condition, the ceramic particles and the resin component were dispersed uniformly.

As described above in detail, according to the first embodiment of the present invention, it is possible to produce the ceramic raw material consisting of the superior uniformly-dispersed ceramic particles and resin component.

### Second Embodiment

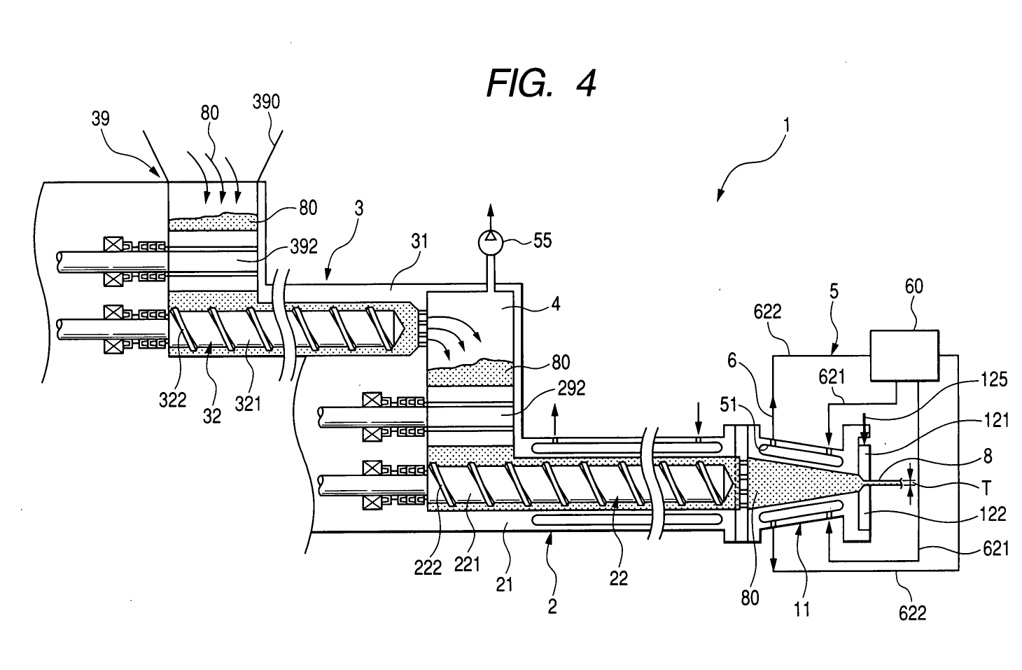

A description will now be given of the method of producing ceramic molded body according to a second embodiment of the present invention with reference to FIG. 4 to FIG. 10, and FIG. 16.

The method of the second embodiment produces a ceramic molded body by using the ceramic raw material produced by the method of the first embodiment shown in FIG. 1 to FIG. 3, and FIG. 15. In the method of the second embodiment, the ceramic molded body is fired in order to produce a sintered body.

In the method of the second embodiment, water is firstly added to the ceramic raw material produced by the method of the first embodiment and then mixing them in order to produce the mixed material, and the mixed material is extruded and molded to a sheet-shaped ceramic molded body.

The extrusion and molding steps of the second embodiment produce the ceramic molded body by using an extrusion molding apparatus 1 as shown in FIG. 4 to FIG. 7.

The extrusion molding apparatus 1 used in the second embodiment shown in FIG. 4 has a lower screw extruder 2 having a screw 22 and an upper screw extruder 3 having a screw 32, and a shaping die 11 placed at a front part of the lower screw extruder 2. The extrusion molding apparatus 1 extrudes the mixed material 80 to the lower screw extruder 2, and molds the ceramic molded body 8 of a sheet shape through the shaping die 11. The shaping die 11 consists of a temperature adjusting means 5 and plural portions through which the mixed material 80 is divided in wide direction into plural parts. The temperature adjusting means 5 adjusts each of the plural portions (as chambers 51) at a specified temperature, respectively.

The configuration and action of the extrusion molding apparatus 1 of the second embodiment will now be explained.

As shown in FIG. 4, the extrusion molding apparatus 1 of the second embodiment has the lower screw extruder 2 and the upper screw extruder 3 connected in series, and the shaping die 11 placed at the front part of the lower screw extruder 2.

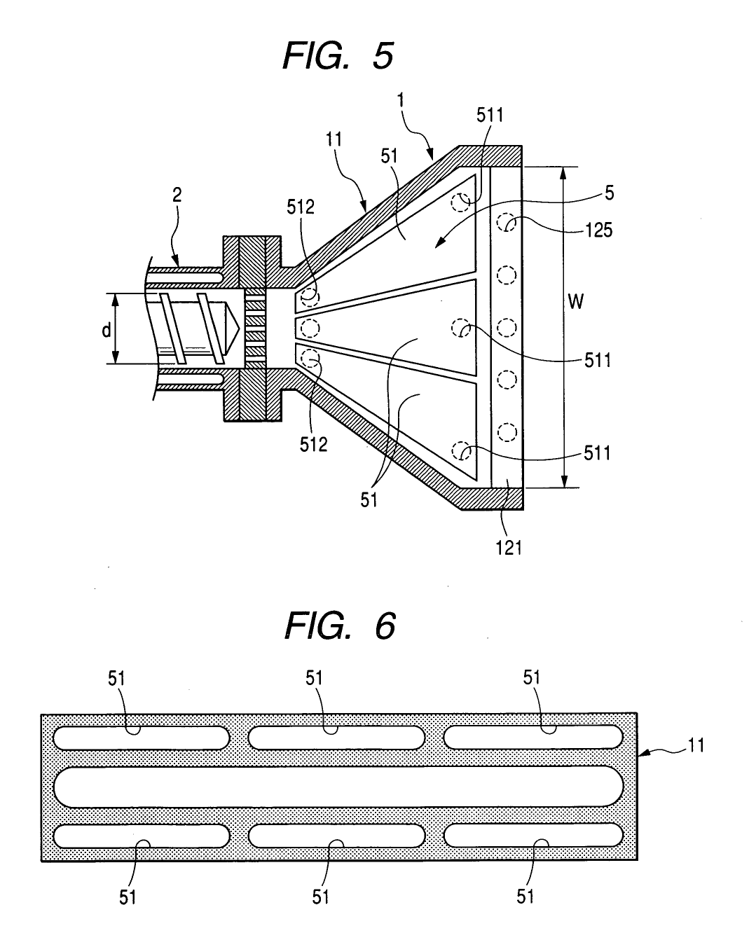

As shown in FIG. 4 and FIG. 5, the shaping die 11 is of a funnel shape in which one end of a cylindrical tube is pushed and the diameter of the shaping die 11 is gradually wide and its vertical height is gradually narrow from its bottom part (connected to the lower screw extruder 2) to its front part.

As shown in FIG. 4, a pair of caps 121 and 122 is placed at the front part of the shaping die 11 in order to adjust or limit the thickness of the ceramic molded body 8 to be supplied to the outside. The upper cap 121 is placed shiftably in a forth-and-back direction by adjusting the shifting amount of an adjusting screw 125 in order to adjust a gap between the upper cap 121 and the lower cap 122.

As shown in FIG. 4, FIG. 5, and FIG. 6, the shaping die 11 has the plural chambers 51 and a heating medium circulating means 60 through which a coolant is circulated through the plural chambers 51. The shaping die 11, as shown in FIG. 4 and FIG. 5, is divided into three parts in its wide direction “W” and into three parts in its up-down direction, respectively. As shown in FIG. 5 and FIG. 6, each chamber 51 is equipped with a heating medium inlet 511 and a heating medium outlet 512 connected to circulating pipes 621 and 622 of the heating medium circulating means 60, respectively.

The thermal medium circulating means 60 is configured to circulate the heating medium 6 of a desired amount into each chamber 51 from a thermal medium tank under the control of a pump (not shown) and a solenoid controlled valve (not shown).

There are various control manners and configurations of the thermal medium circulating means 60. For example, it is acceptable to perform the automatic control by a feedback manner. The second embodiment does not adopt such an automatic control manner, but is configured to adjust a temperature of and a flow amount of the heating medium 6 for cooling each chamber 51 by manual.

As shown in FIG. 4, the lower screw extruder 2 has a pressure screw 22 placed in a housing 21. A spiral shaped lead 222 is formed on the outer surface of an axis body 221 of the pressure screw 22. Similarly, the upper screw extruder 3 has a pressure screw 32 placed in a housing 31. A spiral shaped lead 322 is formed on the outer surface of an axis body 321 of the pressure screw 32. In the second embodiment, the pressure screw 22 has an outer diameter “d” (as the outer diameter of the spiral shaped lead 222) of 30 mm (d=30 mm), and the pressure screw 32 has an outer diameter “d” (as the outer diameter of the spiral shaped lead 322) of 30 mm (φ=30 mm).

A vacuum chamber 4 is placed between the pressure screw 22 and the pressure screw 32. A raw material supply chamber 39 is placed at the rear-upper part of the upper screw extruder 3, through which the ceramic raw material is supplied into the extrusion molding apparatus 1 shown in FIG. 4.

Further, as shown in FIG. 4, the raw material supply chamber 39 has an opening part 390 of an inverted quardrangular pyramid shape and a pair of pressure rollers 392 placed on either side under the opening part 390. A pair of the pressure rollers 392 feeds the mixed material 80 of the ceramic raw material into the pressure extruder 3.

The vacuum chamber 4 is configured to vacuum the mixed material 80 extruded by the upper pressure extruder 3 by a pump 55. The vacuum chamber 4 has a pair of pressure rollers 292 placed on either side under the bottom of the vacuum chamber 4, like the configuration of the raw material supply chamber 39.

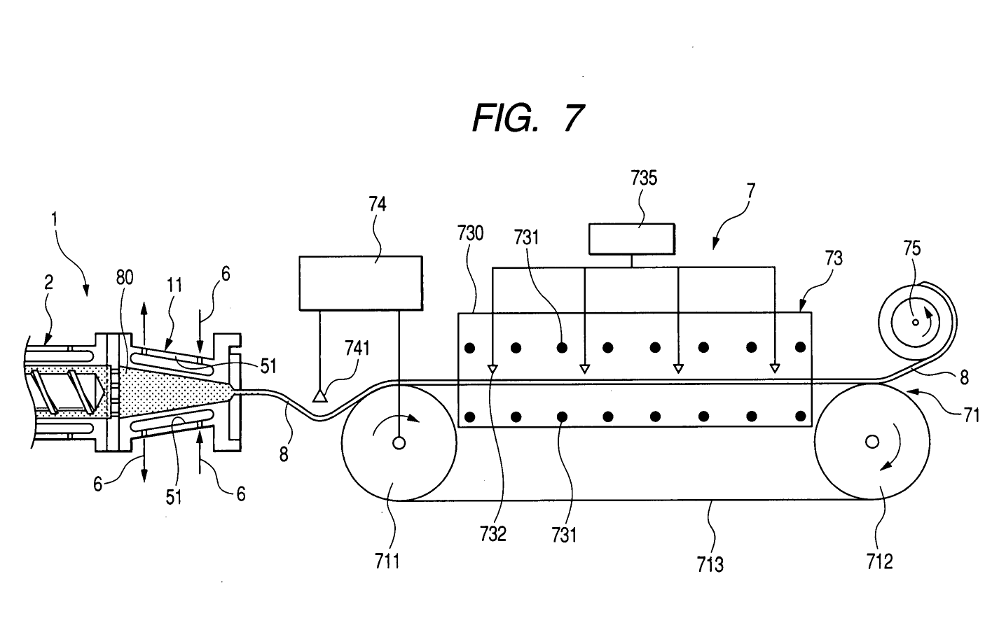

As shown in FIG. 7, the second embodiment of the present invention discloses a drying apparatus 7 configured to dry the ceramic molded body 8 produced by the extrusion molding apparatus 1 and to then roll the ceramic molded body 8. The drying apparatus 7 has a belt conveyor 71. The belt conveyor 71 is equipped with a pair of pulleys 711 and 712 and a belt 713 driven by the pulleys 711 and 712. The drying apparatus 7 further has a heater chamber 73 through which the belt conveyor 71 moves.

The heater chamber 73 has a heater 731 and a temperature sensor 732 placed in a case 730. A heater controller 735 controls the operation of the heater 731 in order to keep constant a temperature of the inside of the heater chamber 73 based on the detection value of the temperature sensor 732.

A displacement sensor 741 and a speed controller 74 are placed at the inlet part of the belt conveyor 71. The displacement sensor 741 measures an amount of deflection of the ceramic molded body 8 made by the extrusion molding apparatus 1. The speed controller 74 controls a transmission speed of the belt conveyor 713 in order to keep constant the amount of deflection of the ceramic molded body 8 based on the measurement value obtained by the displacement sensor 741. A coiler or a reel 75 is placed at the outlet side of the belt conveyor 71. The coiler 75 winds the sheet shaped ceramic molded body 8 after drying.

A description will now be given of a concrete example of producing the ceramic molded body 8 by the extrusion molding apparatus 1 and the drying apparatus 7 according to the second embodiment.

FIG. 16 is a flow chart showing the steps of the method of producing a ceramic molded body performed by the extrusion molding apparatus 1 and the drying apparatus 7 according to the second embodiment.

At first, the mixed material 80 was made by adding water into the ceramic raw material E1 and mixing the added one. That is, the mixed material 80 was made by adding water of 5 parts by weight into the ceramic raw material of 95 parts by weight, and then mixing them (Step S21).

The size of the sheet shaped ceramic molded body 8 to be finally produced has a width “W” (see FIG. 5) of 150.0 mm and a thickness “T” (see FIG. 4) of 200.0 μm. It is so formed that the shaping die 11 corresponds in size to the ceramic molded body 8. The relationship between the outer diameter “d” (see FIG. 5) of the pressure screw 22 of the lower screw extruder 2 and the width “W” of the ceramic molded body 8 becomes W>=3d.

In the shaping step of the ceramic molded body 8, the mixed material 80 is firstly supplied into the extrusion molding apparatus 1 through the material supply chamber 39 (Step S21).

The supplied mixed material 80 is fed into the upper pressure extrusion 3, placed the bottom of the material supply chamber 39, by a pair of the pressure rollers 392 (Step S22). The mixed material 80 in the upper pressure extrusion 3 of the extrusion molding apparatus 1 is extruded forward into the vacuum chamber 4 while mixing it by the rotation of the pressure screw 32. The mixed material 80 vacuumed in the vacuum chamber 4 is fed into the lower pressure extrusion 2 by a pair of the pressure rollers 292 (Step S22).

The mixed material 80 in the upper pressure extrusion 2 is extruded forward into the shaping die 11 while mixing it by the rotation of the pressure screw 22. The ceramic mixed material 80 is shaped by the shaping die 11 as the ceramic molded body 8 of a sheet shape. The ceramic molded body 80 is then supplied to the outside through caps 121 and 122 attached to the shaping die 11 (Step S23). In the second embodiment, a pressure of approximately 10 MPa is applied to the mixed material 80 while shaping. It is preferred that the magnitude of such a pressure is within a range of 1 MPa to 50 MPa that will be explained later (Step S23).

The extruded ceramic molded body 8 of a sheet shape is dried by the drying apparatus 7 and then wound into a coil shaped body (Step S24).

In order to modify the shape of the ceramic molded body 8 in the extrusion and molding manner of the second embodiment, the mixed material 80 to be extruded and shaped is divided in its wide direction into plural parts while adjusting the temperature of each divided part by the temperature adjusting means 5.

In a concrete example, at the initiation of shaping step, the heating medium circulating means 60 circulates the heating medium of 10° C. through the entire of the chambers 51.

While observing the shape of the ceramic molded body 80 to be shaped, the heater controller 735 performs one or both of following operations (a) and (b):

(a) Decreasing the temperature of the heating medium flowing through the chamber 51 corresponding to a wrinkle area generated in the ceramic molded body 80 because of a highly shaping rate; and

(b) Increasing the temperature of the heating medium flowing through the chamber 51 not corresponding to a wrinkle area generated in the ceramic molded body 80.

The flowing rate of the mixed material 80 passing through the shaping die 11 is thereby adjusted at each chamber 51, and as a result the forwarding speed of the ceramic mixed material 80, extruded and shaped, passing through the caps 121 and 122 can be set approximately to a constant rate in wide direction.

Next, the ceramic molded body having a thickness of 200 μm produced by the above manner is fired in order to make a sintered ceramic body (Step S25).

In a concrete example, the ceramic molded body having a thickness of 200 μm is cut into plural parts, each part has a dimension of 150 mm×150 mm. Each divided part is fired at a temperature of approximately 1500° C. for 15 hours in order to make a sintered body. This sintered body will be referred to as “Sample E2”.

Next, the presence of porous parts such as void and pore generated in the sintered body, namely, Sample E2 was measured by a scanning electron microscope (SEM).

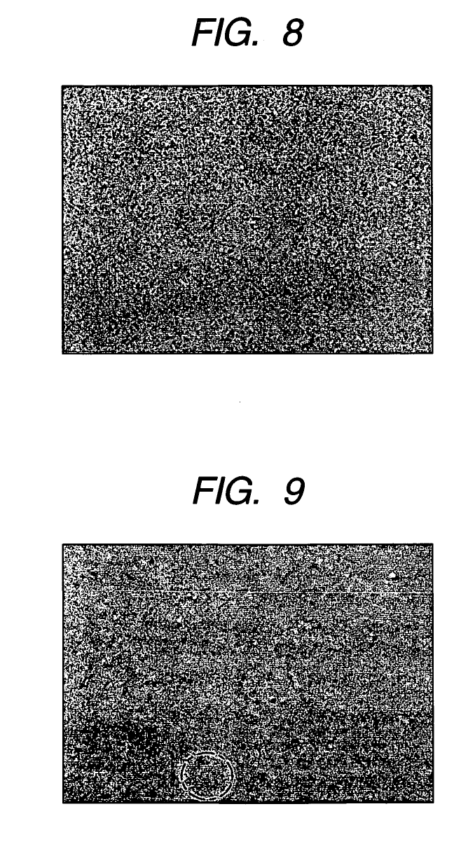

The surface of Sample E2 was polished up to 0.05 mm depth. The SEM observed the polished surface of Sample E2. FIG. 8 shows the measurement result of Sample E2 obtained by the SEM.

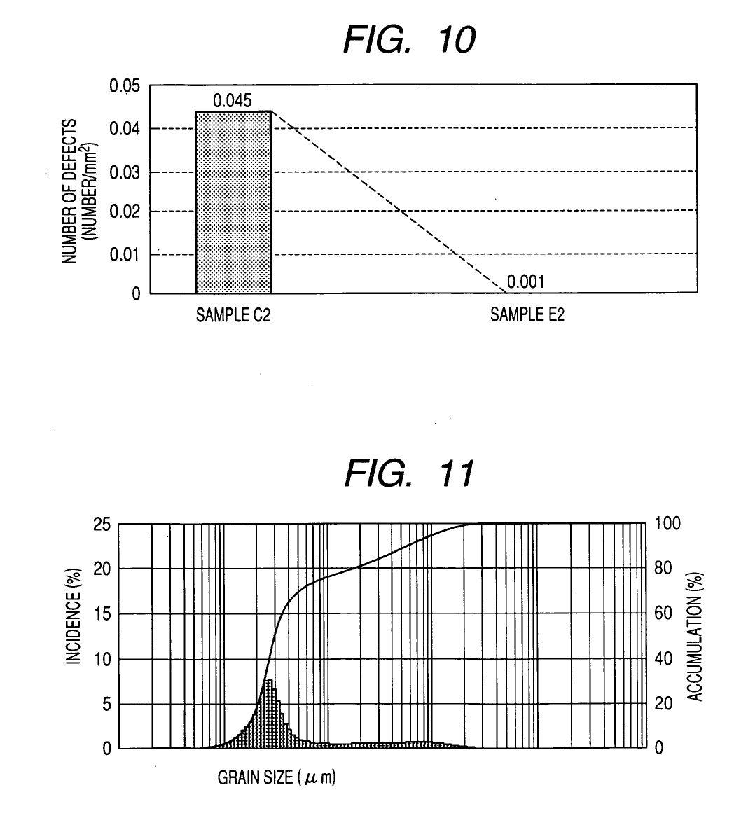

The number of porous parts (such as voids or pores) in a specified area in Sample E2 was counted by the observation using SEM, and the number of defects per area (number/mm²) was calculated. FIG. 10 shows the calculation result.

Further, in the second embodiment, a sintered body (Sample C2) was prepared by mixing ceramic particles and resin component without adding water, by molding, and then by firing the mixed matter. This sintered body (Sample C2) is a comparison sample to be compared with Sample E2. In a concrete example, zirconia particles of 85 parts by weight as ceramic particles and polyvinyl butyral (PVB) of 15 parts by weight as resin component were mixed. The ceramic molded body of a sheet shape having a thickness of 200 μm was formed from the mixed material based on a doctor blade manner. Next, the ceramic molded body was cut into a plurality of parts, each part having a dimension of 150 mm×150 mm, and then fired at a temperature of 1500° C. for 50 hours in order to make the sintered body as Sample C2.

Similar to the case of Sample E2, the presence of porous parts such as void and pore generated in Sample C2 was measured by using SEM. The surface of Sample C2 was polished up to 0.05 mm depth. The SEM observed the polished surface of Sample C2. FIG. 9 shows the measurement result of Sample C2 obtained by the SEM. The number of porous parts (such as voids or pores) in a specified area in Sample C2 was counted by the observation using SEM, and the number of defects per area (number/mm²) was calculated. FIG. 10 shows the calculation result.

As clearly shown from FIG. 8, there is little or no porous part in Sample E2. On the contrary, as shown in FIG. 9, there are porous parts in Sample C2. The porous part is indicated by a dotted circle.

As shown in FIG. 10, Sample C2 has the porous part of approximate 0.045/mm². On the contrary, Sample E2 has only the porous part of 0.001/mm². That is, it may be said that Sample E2 has little porous part.

### Third Embodiment

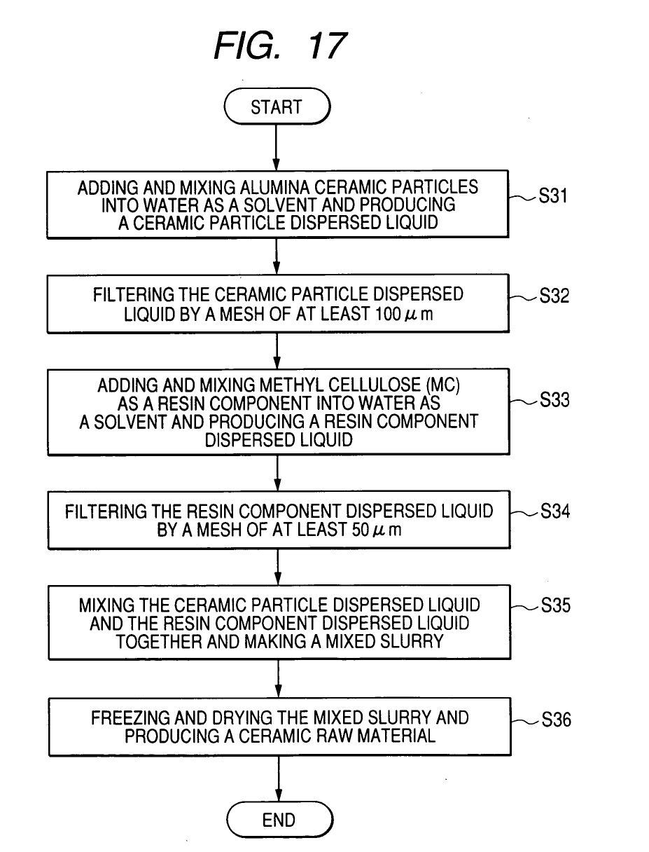

A description will be given of the method of producing a ceramic raw material according to a third embodiment of the present invention with reference to FIG. 11 to FIG. 14, and FIG. 17. The particles in the ceramic raw material produced by the method of the third embodiment have an average grain size of a small variation. The method of the third embodiment performs a ceramic particle filtering and categorizing step and a resin component filtering and categorizing step in addition to the steps of the method according to the first embodiment. FIG. 17 is a flow chart showing the steps of the method of producing the ceramic raw material according to the third embodiment.

In a concrete example of the method according to the third embodiment, alumina particle powder on the market was firstly prepared as ceramic particles. The alumina particle of 50 parts by weight and water of 50 parts by weight were mixed in order to make the ceramic particle dispersed liquid. The amount of pure water as a solvent to the amount of the ceramic particles can be optionally changed. For example, it is acceptable to have the amount of pure water within a range of 20 to 80 wt % to the amount of the ceramic particle dispersed liquid (Step S31).

Next, the ceramic particle dispersed liquid was filtered by a mesh of at least 100 μm (Step S32). In order to check the presence of a large scale particle after the filtering, the ceramic particle dispersed liquid was measured before and after filtering based on a laser diffraction and scattering manner by using MT3300EX (Particle size analyzer “Microtrack”, NIKKISO CO., LTD)

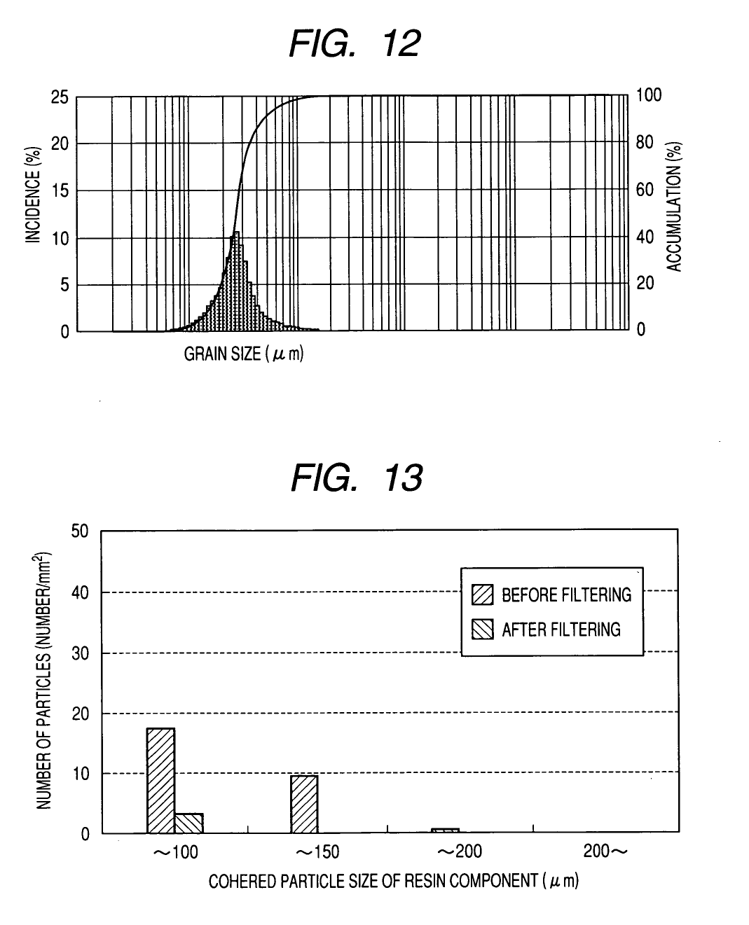

FIG. 11 and FIG. 12 show the measurement result. FIG. 11 shows the incidence or distribution of the grain size as the measurement result in the ceramic particle dispersed liquid before filtering, and FIG. 12 shows the incidence or distribution of the grain size as the measurement result in the ceramic particle dispersed liquid after filtering

As clearly indicated from FIG. 11 and FIG. 12, it can be clearly understood that the latter case shown in FIG. 12 has a smaller variation of the average grain size distribution, that is, the execution of the filtering can reduce the variation of the average grain size or diameter.

Next, methyl cellulose (MC) was prepared as the resin component. The methyl cellulose of 2 parts by weight was then mixed into pure water of 98 parts by weight in order to make the resin component dispersed liquid (Step S33). The amount of pure water to the amount of the resin component can be optionally changed. For example, it is acceptable to have the amount of pure water within a range of 50 to 99 wt % to the amount of the resin component dispersed liquid.

Next, the resin component dispersed liquid was filtered by a mesh of at least 50 μm (Step S34). In order to check the presence of a large scale particle after the filtering, the resin component dispersed liquid was measured before and after filtering based on a laser diffraction and scattering manner by using MT3300EX (Particle size analyzer “Microtrack”, NIKKISO CO., LTD)

FIG. 13 shows the distribution of particles of the resin component per area in the resin component dispersed liquid as the measurement result before and after the filtering. The particle size or diameter distribution of the resin component was measured by the following manner.

First, a part of the resin component dispersed liquid before and after the filtering was dried in a sheet shape, and the dried sheet shaped one was measured by SEM in order to count the number of cohered particles per area. As indicated from FIG. 13, it can be understood that a large sized particles of not less than 100 μm were completely eliminated after the filtering.

Next, the ceramic particle dispersed liquid after filtering and the resin component dispersed liquid after filtering were mixed together in order to make a mixed slurry (Step S35). The mixed slurry was frozen and dried by the same manner of the first embodiment in order to make the ceramic raw material. This product will be referred to as “Sample E3” (Step S36).

In the third embodiment, another ceramic raw material (Sample E4) was prepared as a comparison sample to be compared with Sample E3 by mixing ceramic particle dispersed liquid and resin component dispersed liquid without performing the filtering. Sample E4 was made by the same manner of producing Sample E2 other than the filtering.

That is, Sample E4 was made by mixing the ceramic particle dispersed liquid and the resin component dispersed liquid together, and then by freezing and drying the mixed liquid, where the ceramic particle dispersed liquid was prepared by mixing the alumina particles of 50 parts by weight and the water of 50 parts by weight, and the resin component dispersed liquid was prepared by mixing the methyl cellulose of 2 parts by weight and the water of 98 parts by weight Next, water of 5 parts by weight is added into each ceramic raw material of 95 parts by weight of Sample E3 and Sample E4 in order to make the ceramic mixed material. The amount of water in each ceramic mixed material can be optionally adjusted within a range of 1 to 20 wt %, for example.

Next, the ceramic mixed material was formed by the same manner of the first embodiment so as to produce the ceramic molded body of a sheet shape. The shaping was performed at the pressure within a range of 5 MPa to 50 MPa, the thickness of the ceramic molded body was set within a range of 1 mm to 4 mm. The ceramic molded body produced from Sample E3 will be referred to as Sample E3a, and the ceramic molded body produced from Sample E4 will be referred to as Sample E4a.

In the third embodiment, a ceramic molded body of a sheet shape was produced as Sample C3a, to be compared, by mixing ceramic particles and resin component without adding water. In a concrete example, alumina particle powder on the market was firstly prepared as ceramic particles.

The alumina particle of 85 parts by weight and polyvinyl butyral (PVB) of 15 parts by weight as resin component were mixed. The mixed material was molded by doctor blade manner. The ceramic molded body will be referred to as Sample C3a.

Next, three Samples E3a, E4a, and C3a were observed by SEM in order to obtain the distribution of average grain size or diameter per area.

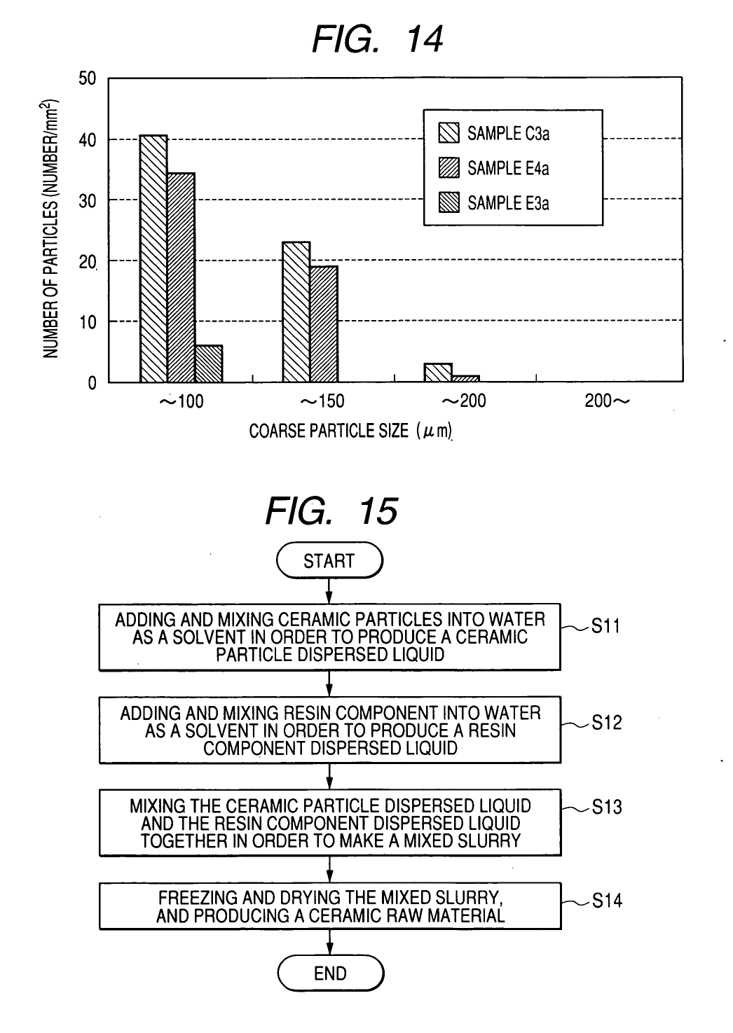

FIG. 14 is a bar graph showing the distribution of coarse particles per area and particle size in each ceramic molded body (Experimental samples E3a, E4a, and C3a);

As clearly shown in FIG. 14, Sample E4a and Sample C3a have many coarse particles of a grain size or diameter of not less than 100 μm. On the contrary, Sample E3a has no coarse particles of not less than 100 μm.

Next, each molded body (Sample E3a, Sample E4a, and Sample C3a) were fired in order to make sintered ceramic products. In the third embodiment, a gas sensor element was produced by using each sintered ceramic product composed of a solid electrolyte body, a pair of electrodes, an insulation layer, and a heater. The solid electrolyte body is laminated between a pair of the electrodes. Each molded body (Sample E3a, Sample E4a, and Sample C3a) of a sheet shape was used as the insulation layer.

The gas sensor element as Sample E3b was produced by using Sample E3a. The gas sensor element as Sample E4b was produced by using Sample E4a. The gas sensor element as Sample C3b was produced by using Sample C3a.

In the gas sensor elements, the insulation layer was made from the sintered Sample E3a, Sample E4a, and Sample C3a by firing.

In the third embodiment, twenty gas sensor elements were produced, respectively, as each of Sample E3b, Sample E4b, and Sample C3b.

Next, Voltages of 14 V, 15V, and 16V were applied to the heaters in the gas sensor elements as Sample E3b, Sample E4b, and Sample C3b, respectively, in order to apply the heating stress to them. The presence of cracks generated in the insulation layer of each gas sensor element was observed. The generation rate of cracks in each of Samples E3b, Samples E4b, and Samples C3b was then calculated based on the observation results.

A following Table 1 shows the calculation result described above.

TABLE 1
(Generation Rate)

| | Applied voltage | | |
|---|---|---|---|
| Sample No. | 14 V | 15 V | 16 V |
| Sample E3b | 0% | 0% | 0% |
| Sample E4b | 0% | 0% | 15% |
| Sample C3b | 0% | 5% | 16% |

As clearly shown in Table 1, there is no crack in Sample E3b produced from the ceramic raw material of Sample E3. In Sample E4b produced from the ceramic raw material of Sample E4, the cracks were generated at a rate of 15% on applying a high voltage of 16V. On the contrary, In Sample C3b produced from the ceramic raw material of Sample C3, the cracks were generated at a rate of 5% on applying even a low voltage of 5V.

As clearly understood from the above experimental results, it is possible to suppress the generation of defects such as cracks and voids in the ceramic product (gas sensor element E3b) by using Sample E3 from which coarse particles having a grain size of not less than 100 μm were eliminated by filtering.

While specific embodiments of the present invention have been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present invention which is to be given the full breadth of the following claims and all equivalent thereof.

What is claimed is:

1. A method of producing ceramic raw material composed mainly of at least ceramic particles and resin component, comprising steps of:
producing ceramic particle dispersed liquid by mixing ceramic particles and water;
producing a resin component dispersed liquid by mixing resin component and water;
producing a mixed slurry by mixing the ceramic particle dispersed liquid and the resin component dispersed liquid; and
producing the ceramic raw material by freezing and drying the mixed slurry.

2. The method of producing ceramic raw material according to claim 1, wherein the ceramic particles is at least one kind of components selected from a group of aluminum titanate (Al₂TiO₅), mullite (3Al₂O₃.2SiO₂), potassium titanate (K₂O.nTiO₂), Lithium aluminosilicate, cordierite, titanate zirconate (PZT), titanium oxide (TiO₂), tin oxide (SnO₂), Gallium arsenide (GaAs), silicon carbide (SiC), chromic oxide (Cr₂O₃), zirconia (PSZ), alumina (Al₂O₃), yttria (Y), silicon nitride (Si₃N₄), glaphite fiber, calcium silicate (3CaO.SiO₂), crystallized glass, unstable carbon, tungsten carbide (WC), titanium carbide (TiC), iron Silicide (FeSi₂), graphite, titania (titanium oxide TiO₂), carbon fiber, silica (SiO₂), aluminum nitride (AlN), barium titanate (BaTiO3), zinc oxide (ZnO), zinc sulfide (ZnS), gallium phosphide (GaP), tungstic oxide (WO₂), cadmium sulfide (CdS), and Indium Tin oxide (ITO).

3. The method of producing ceramic raw material according to claim 1, wherein the resin component is at least one kind of components selected from a group of methyl cellulose (MC), hydroxypropyl methylcellulose, carboxymethyl cellulose (CMC), hydroxyethyl cellulose (HEC), starch, polyvinyl alcohol (PVA), polyethylene oxide (PEO), sodium polyacrylate, and polyacrylamide (PAA).

4. The method of producing ceramic raw material according to claim 2, wherein the resin component is at least one kind of components selected from a group of methyl cellulose (MC), hydroxypropyl methylcellulose, carboxymethyl cellulose (CMC), hydroxyethyl cellulose (HEC), starch, polyvinyl alcohol (PVA), polyethylene oxide (PEO), sodium polyacrylate, and polyacrylamide (PAA).

5. The method of producing ceramic raw material according to claim 1, further comprising a step of filtering the ceramic particle dispersed liquid in order to eliminate and classify coarse particles having a grain size of at least not less than 100 μm from the ceramic particle dispersed liquid.

6. The method of producing ceramic raw material according to claim 2, further comprising a step of filtering the ceramic particle dispersed liquid in order to eliminate and classify coarse particles having a grain size of at least not less than 100 μm from the ceramic particle dispersed liquid.

7. The method of producing ceramic raw material according to claim 3, further comprising a step of filtering the ceramic particle dispersed liquid in order to eliminate and classify coarse particles having a grain size of at least not less than 100 μm from the ceramic particle dispersed liquid.

8. The method of producing ceramic raw material according to claim 1, further comprising a step of filtering the resin component dispersed liquid in order to eliminate and classify coarse particles having a grain size of at least not les than 100 μm from the resin component dispersed liquid.

9. The method of producing ceramic raw material according to claim 2, further comprising a step of filtering the resin component dispersed liquid in order to eliminate and classify coarse particles having a grain size of at least not les than 100 μm from the resin component dispersed liquid.

10. The method of producing ceramic raw material according to claim 3, further comprising a step of filtering the resin component dispersed liquid in order to eliminate and classify coarse particles having a grain size of at least not les than 100 μm from the resin component dispersed liquid.

11. The method of producing ceramic raw material according to claim 5, further comprising a step of filtering the resin component dispersed liquid in order to eliminate and classify coarse particles having a grain size of at least not less than 100 μm from the resin component dispersed liquid.

12. The method of producing ceramic raw material according to claim 1, further comprising a step of filtering the mixed slurry in order to eliminate and classify coarse particles of the ceramic particles and the resin component having a grain size of at least not les than 100 μm from the mixed slurry.

13. The method of producing ceramic raw material according to claim 2, further comprising a step of filtering the mixed slurry in order to eliminate and classify coarse particles of the ceramic particles and the resin component having a grain size of at least not les than 100 μm from the mixed slurry.

14. The method of producing ceramic raw material according to claim 3, further comprising a step of filtering the mixed slurry in order to eliminate and classify coarse particles of the ceramic particles and the resin component having a grain size of at least not les than 100 μm from the mixed slurry.

15. A method of producing a ceramic molded body, comprising steps of:
adding water into the ceramic raw material produced by the method according to claim 1 and then mixing the ceramic raw material and the water;
extruding the mixed material by applying a pressure of a range of 1 to 50 MPa and molding the mixed material in order to produce a ceramic molded body.

16. A method of producing a ceramic molded body, comprising steps of:
adding water into the ceramic raw material produced by the method according to claim 2 and then mixing the ceramic raw material and the water; and
extruding the mixed material by applying a pressure of a range of 1 to 50 MPa and molding the mixed material in order to produce a ceramic molded body.

17. A method of producing a ceramic molded body, comprising steps of:
adding water into the ceramic raw material produced by the method according to claim 3 and then mixing the ceramic raw material and the water; and
extruding the mixed material by applying a pressure of a range of 1 to 50 MPa and molding the mixed material in order to produce a ceramic molded body.

18. The method of producing a ceramic molded body according to claim 15, wherein the ceramic molded body is a gas sensor element.
